(19) United States
(12) Patent Application Publication
(10) Pub. No.: US 2004/0255183 A1
(43) Pub. Date: Dec. 16, 2004

(54) Data management method and apparatus and program

(76) Inventor: Toshinari Takahashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/718,520

(22) Filed: Nov. 24, 2003

(30) Foreign Application Priority Data
May 30, 2003 (JP) 2003-155928

(51) Int. Cl. H02H 3/05

(52) U.S. Cl. 714/3

(57) ABSTRACT

A management OS having a higher level of safety than an active OS as a management target is prepared. In the management OS, an OS state detection unit detects the state of the active OS, and a data extraction unit reads out data in a storage device for the active OS. In this form, the two OSs operate in cooperation with each other, thus guaranteeing that all information necessary for failure restoration is sequentially left in a memory save device which the management OS has. This eliminates the difficulty in scheduling data storage and solves the problem that the data management system itself may be damaged by a computer virus and the like.

### CROSS-REFERENCE TO RELATED APPLICATIONS

This application is based upon and claims the benefit of priority from the prior Japanese Patent Application No. 2003-155928 filed May 30, 2003, the entire contents of which are incorporated herein by reference.

### BACKGROUND OF THE INVENTION

1. Field of the Invention

The present invention relates to a data management apparatus, data management method, and program which save and restore data associated with a computer to restore the computer from a failure.

2. Description of the Related Art

A failure occurs in a computer when, for example, hardware fails or software (data in a storage device) is erroneously corrected. In failure restoration, it is most important whether or not the state of the software before the occurrence of the failure can be accurately restored. There are three main kinds of restoration method in conventionally known computer failure-restoration devices.

In the first method, storage devices are multiplexed, and an active OS writes, in the second storage device, the same data as that written in the first storage device, thereby restoring the data in the first storage device by using the data stored in the second storage device if the data in the first storage device is destroyed. For example, direct access from the active OS to the second storage device is inhibited, and an active storage device (active disk) is switched from the first storage device to the second storage device when a failure occurs, thereby instantaneously performing failure restoration. Such a scheme is disclosed in, for example, U.S. Pat. No. 6,175,904 issued Jan. 16, 2001 (title of the invention: “APPARATUS AND METHOD FOR PROVIDING A TRANSPARENT DISK DRIVER BACK-UP”). An advantage of this scheme is that when, for example, a storage device such as a hard disk physically fails, the computer can be quickly restored to a state immediately before the occurrence of the failure. However, there are not very many types of failures which completely disable computers immediately after the occurrence of the failure. In practice, a computer keeps operating after the occurrence of a failure, and, for example, the user often tries to restore the computer from the failure upon reception of a failure report a few days later. According to this scheme, since data at the time of the occurrence of the failure has already been lost, the computer cannot be restored from the failure. That is, since a specific time point corresponding to the timing of the occurrence of a failure cannot be detected in real time, it is very likely that data necessary for failure restoration is lost in this scheme.

In the second method, software for backing up data is made to always operate on an active OS or to operate at desired timings to sequentially store, in the second storage device, data in a storage device which has been changed by the active OS. For example, there is available a scheme of storing a state (snapshot) immediately before the installation of a new application in order to prevent the occurrence of a failure due to the installation of the application. For example, Windows Me™ available from US Microsoft™ (released in September 2000) incorporates such a scheme as the function “System Restore”. For example, this information is disclosed in

http://www.microsoft.com/default.aspx?scid=kb;EN-US;267 951:

Microsoft(™) Windows(™) provides “System Restore”, that is designed to monitor and record changes made to the core Windows system files and to the registry (the system property file).

The “System Restore” program runs on the Windows Operating system itself which is to be monitored and recorded the changes to.

By using this scheme, since a plurality of states can be stored, unlike in the first method, there is a higher possibility that data necessary for failure restoration will remain. In this scheme, however, since the data necessary for failure restoration is also managed as data for the active OS, the software for failure restoration itself may be damaged. It is therefore likely that the data necessary for failure-restoration will be lost. For example, this scheme is almost helpless against damage caused by software designed for system destruction, i.e., called computer viruses.

In the third method, an OS designed to back up data is made to operate independently of an active OS to store data in a shutdown state of the active OS which is temporarily shut down in backup processing. For example, this method is used for a product such as “Norton Ghost™” available from US Symantec™. This product is disclosed in

http://www.amazon.co.uk/exec/obidos/ASIN/B00006JDOU/ref %3Ded%5Fbest%5Fh%5F1%5F9/t/026-0824545-5516433:

Symantec's Norton Ghost(™) enables users to create disk images and store them on hard disk drives. The product runs on the Microsoft(™) Windows(™) operation systems itself which is to be stored, or another operating system (DOS) stores the target operation systems while it stops.

This method is currently used most widely. An advantage of the method is that data necessary for failure restoration can be reliably stored without being influenced by the behavior of the active OS. This method needs to detect that a “moving state” to be stored is the current state. The method can therefore be used to, for example, store (back up) data before dangerous operation which may destroy the OS, but is of little use to the most important purpose, i.e., restoring the computer to the state before the occurrence of a failure whose occurrence time cannot be generally predicted.

### BRIEF SUMMARY OF THE INVENTION

It is an object of the present invention to provide a data management apparatus, data management method, and program which can store data necessary for failure restoration for a computer more reliably than the prior art.

According to a first aspect of the present invention, there is provided a data management system comprising a target operating system which is to be restored from a failure, a storage device which stores the target operating system and data, and a management operating system independent of the target operating system, including an operation state detection unit which detects an operation state of the target operating system when the operation state of the target operating system corresponds to one of a plurality of predetermined operation states, an extraction unit which extracts data to be saved from the storage device in accordance with the operation state detected by the operation state detection unit, and a save storage unit which saves the extracted data.

According to a second aspect of the present invention, there is provided a data management method of causing a management operating system independent of a target operating system to manage data in a storage device which the target operating system has, comprising detecting an operation state of the target operating system when the operation state of the target operating system corresponds to one of a plurality of predetermined operation states, extracting data to be saved from the storage device in accordance with the detected operation state, and saving the extracted data in a save storage device.

According to a third aspect of the present invention, there is provided a program for causing a computer to function as a data management apparatus which causes a management operating system independent of a target operating system to manage data in a storage device which the target operating system has, the program causing the computer to implement a function of detecting an operation state of the target operating system when the operation state of the target operating system corresponds to one of a plurality of predetermined operation states, a function of extracting data to be saved from the storage device in accordance with the detected operation state, and a function of saving the extracted data in a save storage device.

According to the present invention, the management operating system can grasp the operation state of the target operating system, and can extract data from the storage device upon obtaining information indicating that the active OS has stopped or a new application is to be installed. This allows the user to save data necessary for failure restoration more reliably without noticing the operation state of the target operating system, thus allowing the user to have data for restoration to a state at a given time point before the occurrence of a failure.

### BRIEF DESCRIPTION OF THE SEVERAL VIEWS OF THE DRAWING

FIG. 1 is a view showing an example of the arrangement of a computer system including a data management system according to the first embodiment of the present invention;

FIG. 2 is a view for explaining implementation forms of an active OS 1 and management OS 2;

FIG. 3 is a view for explaining implementation forms of the active OS 1 and management OS 2;

FIG. 4 is a flow chart showing an example of a processing sequence for the management OS;

FIG. 5 is a view for explaining processing by the management OS;

FIG. 6 is a view for explaining processing by the management OS;

FIG. 7 is a view for explaining processing by the management OS;

FIG. 8 is a view showing an example of the arrangement of a computer system including a data management system according to the second embodiment of the present invention;

FIG. 9 is a flow chart showing a processing sequence for the management OS;

FIG. 10 is a view for explaining processing by the management OS;

FIG. 11 is a view showing an example of the arrangement of a computer system including a data management system according to the third embodiment of the present invention;

FIG. 12 is a view showing an example of the arrangement of a computer system including a data management system according to the fourth embodiment of the present invention;

FIG. 13 is a view for explaining implementation forms of an active OS 1 and management OS 2; and

FIG. 14 is a view for explaining implementation forms of the active OS 1 and management OS 2.

### DETAILED DESCRIPTION OF THE INVENTION

Embodiments of the present invention will be described below with reference to the several views of the accompanying drawing.

(First Embodiment)

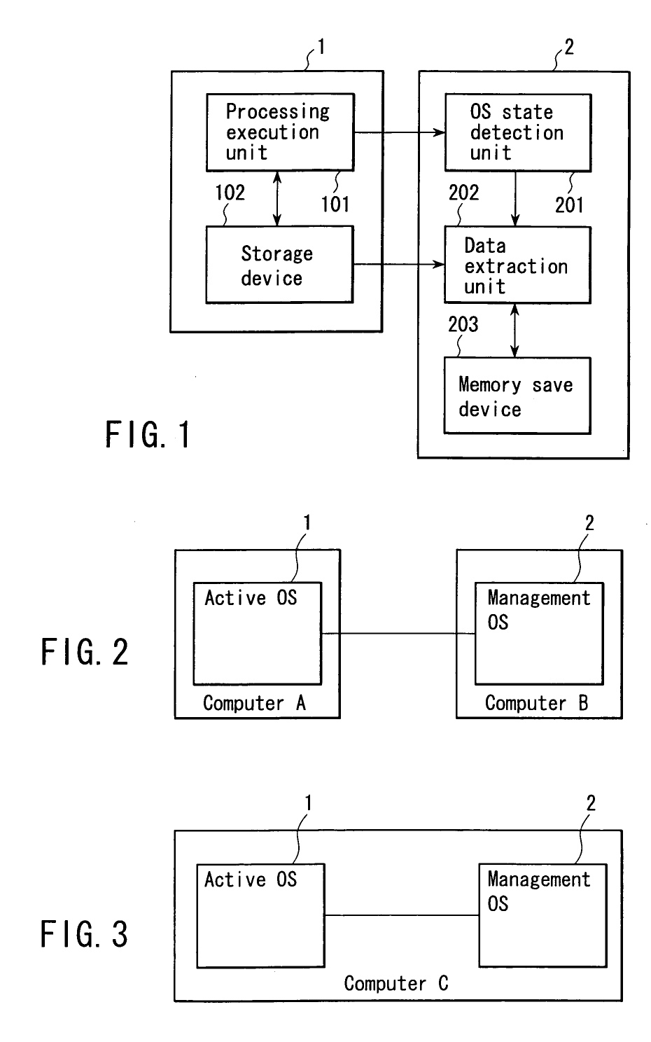

FIG. 1 shows an example of the arrangement of a computer system including a data management system according to the first embodiment of the present invention.

Referring to FIG. 1, reference numeral 1 denotes an active OS (target operating system); and 2, a management OS (management operating system). The active OS 1 is a target OS which is to be restored from a failure. The management OS 2 is an OS which is prepared exclusively for failure restoration processing for the active OS 1, and saves data (or files) associated with the active OS 1 in order to restore the active OS 1 from a failure. More specifically, as will be described later, the management OS 2 preferably has a higher level of safety than the active OS 1.

In general, an OS may indicates only a software portion for managing a computer. In this embodiment, however, an OS indicates a system including peripheral devices such as a storage device. A plurality of OSs may be installed and operated in a computer system. In this case, therefore, a computer system indicates only a portion used by an active OS, which is a main component of the OSs, or only a portion used by a management OS.

System arrangements can be roughly classified into: an arrangement in which the active OS 1 and management OS 2 are implemented on different computers A and B, as shown in FIG. 2; and an arrangement in which the active OS 1 and management OS 2 are implemented on a single computer C, as shown in FIG. 3. The former arrangement can take various installation forms, e.g., a form in which the active OS 1 and management OS 2 are connected to each other through a LAN or the like and installed in nearby places within the same computer room or the same building, and a form in which the active OS 1 and management OS 2 are connected to each other through a wide-area network or the like and installed in physically distant places.

The active OS 1 has a processing execution unit 101 for, for example, executing a program, and a storage device 102, for example, in and from which the processing execution unit 101 writes and read data.

The storage device 102 is typically a physical storage medium such as a hard disk or flash storage device. If the processing execution unit 101 is designed to write and read data, the storage device 102 may not have any storage medium. For example, the present invention can also be applied to a case wherein the active OS 1 has a communication line to write and read data in and from an external storage device through the communication line.

The management OS 2 has an OS state detection unit 201, data extraction unit 202, and memory save device 203.

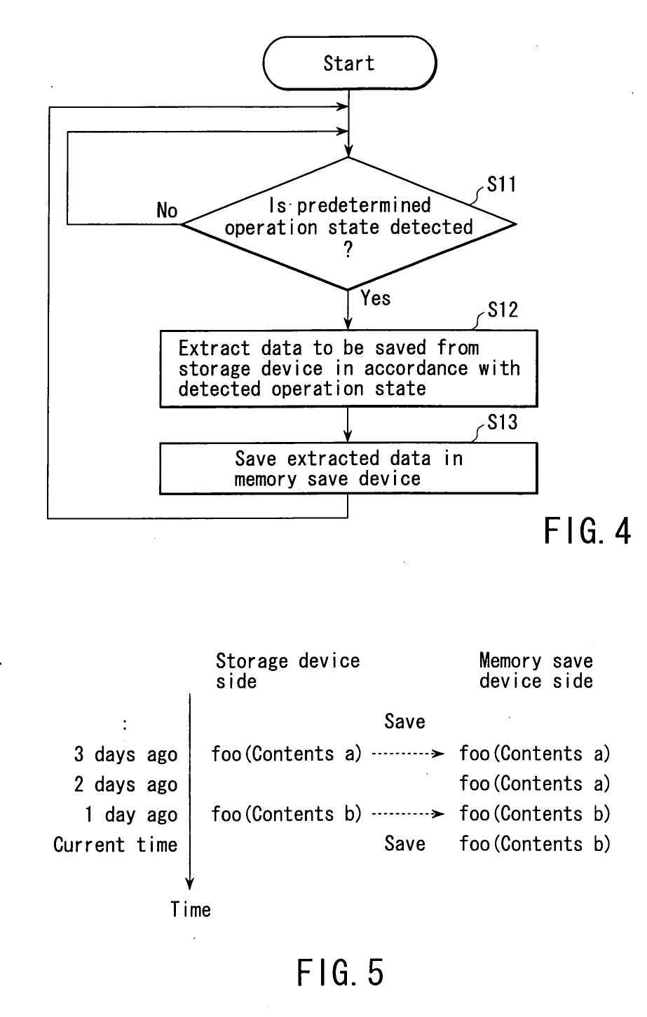

FIG. 4 shows an example of a sequence in which the management OS 2 saves data in the storage device 102.

The OS state detection unit 201 detects the operation state (operation condition) of the target active OS 1 (step S11). That is, the OS state detection unit 201 acquires information about the operation state of the processing execution unit 101 of the target active OS 1.

The data extraction unit 202 extracts (reads out) data to be saved from the OS state detection unit 201 in accordance with the detected operation state (step S12).

The data extraction unit 202 saves (writes) the extracted data in the memory save device 203 (step S13).

The detection of the operation state of the active OS 1 by the OS state detection unit 201 will be described in detail below.

Assume that as information about the operation state, there is information “The processing execution unit 101 terminates processing by the active OS 1 and stops the operation (i.e., performs shutdown).”

When, for example, a notice message for termination is to be sent onto a network immediately before the operation of the active OS 1 stops, the management OS 2 receives the notice message, and the OS state detection unit 201 detects that the active OS 1 will soon be stopped.

In order to make this notification more reliably, for example, the management OS 2 which has received the notice message may send an ICMP (INTERNET CONTROL MESSAGE PROTOCOL) message for a network interface for the active OS 1 to check whether or not the active OS 1 is actually stopped.

The above description has exemplified the case wherein a notice message is sent onto a network. However, the present invention is not limited to any specific means for notifying the management OS 2 of the termination of the active OS 1 or any specific unit as the OS state detection unit 201 which detects the termination of the active OS 1, and may use any kind of method.

As another example of information about the operation state, there is information “The processing execution unit 101 starts processing of the active OS 1 (i.e., boots the OS).”

When, for example, an OS restart message is to be sent onto the network immediately after the active OS 1 starts operating, the management OS 2 receives the restart message, and the OS state detection unit 201 detects that the active OS 1 starts processing.

If this restart message contains a start option for the active OS 1, a better effect can be obtained. For example, the start option is information indicating the specific service (daemon) that the active OS 1 is to execute, the specific version of the OS, and the specific purpose for which the active OS 1 is started. For example, detecting in advance that the active OS 1 is started for the use of a CAD system can realize efficient operation, e.g., allowing the data extraction unit 202 to preferentially update CAD file by using the corresponding information. In addition, the present invention may use a method of transmitting information corresponding to a start option as a separate message, as needed, instead of using the method of containing the information in a restart message.

The above description has exemplified the case wherein a restart message is sent onto a network. However, the present invention is not limited to any specific means for notifying the management OS 2 of the restart of the active OS 1 or any specific unit as the OS state detection unit 201 which detects the restart of the active OS 1, and may use any kind of method.

A further example of information about the operation state, information about the internal operation of the active OS 1 itself is conceivable.

For example, such information includes information “The processing execution unit 101 has written data in the storage device 102.” In this case, all the pieces of data write information may be used one by one or only specific data write information may be used for efficient processing.

A specific data write in the latter case includes, for example, important write operation, e.g., a rewrite on the system area of an OS, or a write in a file created when an application is installed. It is preferable to determine a specific data write in accordance with the properties or application purpose of the active OS 1 or the like. This operation can be realized by describing a rule, as a definition file, by which a specific data write is obtained in accordance with the properties or application purpose of the active OS 1 or the like.

The contents of data contained in information about the operation state may be the name of a file in which data is written or a location (e.g., a track number or node number) in the storage device or, in some cases, the contents of a file update (e.g., updating of data on the third line into given data). Such a rule may be implemented by being described as a definition file in the same manner as described above.

A further example of information about the operation state, information indicating that the active OS 1 has communicated with another computer is conceivable.

As in the above case of the data write, necessary information may be selected from all log data in accordance with a rule. If, for example, there is a communication for an OS update (i.e., a communication with an update site), it can be expected that an important update will be made. If WWW access is made to a dangerous WWW site (e.g., a site where many complicated scripts are written or a site which is recognized in advance as a dangerous site), it can be expected that the computer may possibly be infected with a virus.

According to the above description, when a predetermined operation state is detected, data to be saved is extracted from the storage device 102 in accordance with the operation state and is saved in the memory save device 203. In addition to this operation, data to be saved may be extracted from the storage device 102 and saved in the memory save device 203 every time a predetermined period of time elapses. If a predetermined operation state is detected concurrently with the elapse of a predetermined period of time, for example, priority may be given to the former.

Reading of data to be saved from the storage device 102 by the data extraction unit 202 and saving of the data in the memory save device 203 will be described in detail next.

As methods of reading out data from the data storage device, two kinds of methods can be mainly used. One method is a method of actually reading out data stored in the storage device 102 as in general data read operation. The other method is a method in which when a write instruction for the storage device 102 is issued from the processing execution unit 101, the signal is directly read to obtain an effect equivalent to a data read. In the above case of the storage device incorporating no physical storage device, the latter method is used.

The data extraction unit 202 writes the extracted data in the memory save device 203. This write operation is performed in consideration of a time series (e.g., the time when given data is read out from the storage device 102 or the time when given data is written in the memory save device 203 is stored in correspondence with the given data) unlike general write operation for a file system or the like. That is, processing similar to processing for management of the update log of the data is performed.

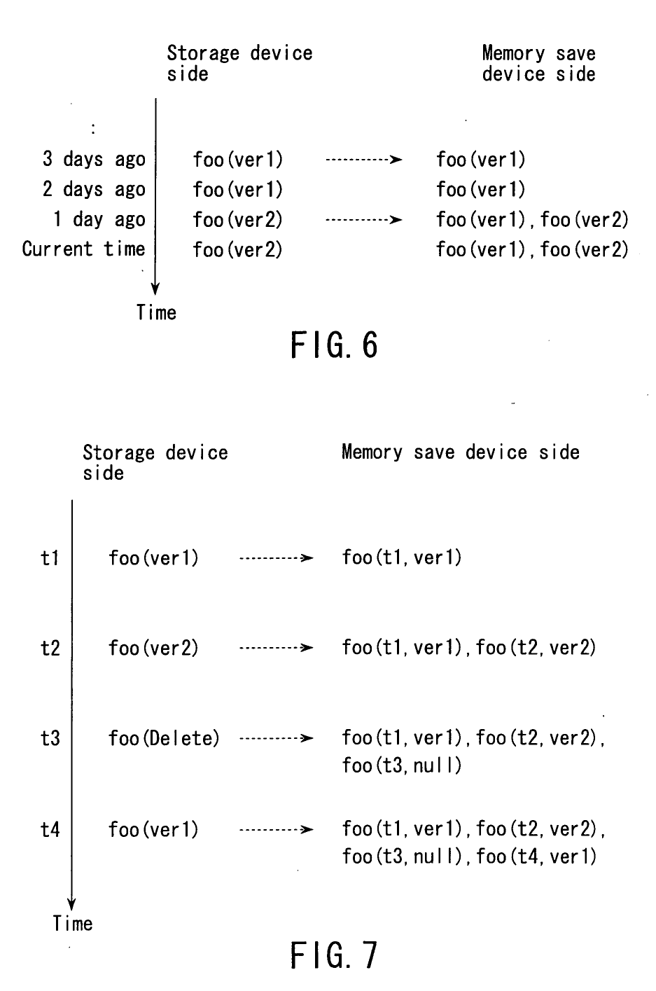

Assume that there is the data (whose contents are represented by a at this time) of a file named “foo” which was extracted and written in the memory save device 203 by the data extraction unit 202 three days ago, as shown in FIG. 5. In this case, when the data extraction unit 202 extracts the data (whose contents are represented by b at this time) of a file named “foo” and overwrites it on the file having the same name in the memory save device 203 afterward (e.g., one day ago), the data for restoration to the state of three days ago is omitted. If, therefore, a failure occurred two days ago, restoration from the failure may not be made. For this reason, this write operation is performed by a method of storing the data of files with the same name at the respective time points (e.g., the respective save time points) upon discriminating them. Note that this discrimination may be done in accordance with the times when the files are saved in the memory save device 203, the version numbers, or the like. FIG. 6 shows a case wherein the contents of files named “foo” are discriminated depending on the versions of the files, and the data of the respective versions are stored.

In addition, for example, after a file “foo” is deleted, a file named “foo” may be created again (there exists no file “foo” in the interval between the instant at which the file is deleted and the instant at which the file is created again). When the file “foo” is deleted, therefore the corresponding information is preferably stored in the memory save device 203. FIG. 7 shows a case wherein information indicating that the file “foo” was deleted at time 13 is saved (although foo(t4, ver1) is equal in version information to foo(t1, ver1), since they differ in time information, they have different contents).

Furthermore, information discriminating whether the file “foo” was newly created, modified, or deleted may be stored in correspondence with the file “foo”.

If, for example, there are a plurality of files named “foo” which differ in their path names, they are handled as different files.

The method of writing data in consideration of a time series unlike general write operation for a file system or the like has been described above. According to this method, as is obvious, written data, i.e., data containing information about a change log of a file, can be easily read out as data stored in the data storage device at a given time point in the past.

When, for example, data is to be read out as data stored in the data storage device two days ago, a file named “foo” with version Ver1 can be automatically read out by simply issuing an instruction to read out a file named “foo” (a file without any version number or the like) in FIG. 6.

When the data extraction unit 202 is to write data extracted from the storage device 102 in the memory save device 203, information indicating the operation state of the active OS 1 which is detected by the OS state detection unit 201 is preferably used. This is because the current condition (current operation state) of the active OS 1 is preferably considered when the state of the active OS 1 is stored.

If, for example, the active OS 1 is completely stopped, it is guaranteed that no change occurs in data in the storage device 102 while the data extraction unit 202 extracts data from the storage device 102. In such a case, there is no need to consider a data extraction schedule, and all possible data may be stored. On the basis of the data, the state at a time point when the active OS 1 is started (turned on) next can be extracted at any time in the future.

On the other hand, when the active OS 1 is operating, data in the storage device 102 may be changed even while the data extraction unit 202 extracts data from the storage device 102. In such a case, if the data extraction unit 202 reads out all data from the storage device 102, the processing efficiency may deteriorate. When, for example, it can be grasped that the user is editing a specific document file, since associated files can be changed every second, efficient operation can be done by preponderantly extracting the data of such files.

In another case, when the active OS 1 tries to register a new application, changes in files associated with the system become an important point, and efficient operation can be done by preponderantly extracting the data of such files (e.g., common library files and system setting files).

These operations may be performed more efficiently by designing an algorithm for the data extraction unit 202 in consideration of the properties of the active OS 1. For example, in some currently known OSs, there is prepared a mechanism for easily extracting files currently edited by the user, and a list of currently edited files or a set of pointers to these files is managed. If the active OS 1 has such properties, specific files which the user has currently operated (changed) preponderantly can be detected by using such information, and the corresponding information can be used for data extraction.

For some currently known OSs, interfaces for the installation (registration) of new applications and uninstallation (deletion) have been standardized. That is, when an application is installed or uninstalled, predetermined software is always started. Assume that the active OS 1 has such properties. In this case, for the active OS 1, such information can be used for data extraction by making the data extraction unit 202 detect that an important change is to be made in failure restoration.

Note that when the data extraction unit 202 is to write data extracted from the storage device 102 in the memory save device 203, information indicating the operation state of the active OS 1 which is detected by the OS state detection unit 201 may also be stored in correspondence with the data.

In the above manner, the management OS 2 can extract data from the storage device 102 upon detecting the operation state of the active OS 1, e.g., obtaining information indicating, for example, that the active OS 1 is stopped or a new application is to be installed. This allows the user to store data necessary for failure restoration without considering the state of the active OS 1, thus eliminating the chance of forgetting to back up data. Even if, therefore, failures occur in various situations, it is guaranteed (or expected) that data for restoring the computer to the state at an arbitrary time point before the occurrence of failures is held in the memory save device 203.

If, for example, the occurrence of a failure is recognized three days after the failure occurred actually, it can be detected that the computer cannot be restored from the failure by using stored data of one day ago or two days ago because the state before the occurrence of the failure cannot be obtained, but can be restored from the failure by using stored data of three days ago. By restoring the state of the storage device 102 to the state of three days ago, therefore, the compute can be restored to the state before the occurrence of the failure.

Note that the computer may inhibit the user from directly using data saved in the memory save device 203. This greatly increases the probability of inhibiting the activation of a computer virus even if a file containing the computer virus is saved in the memory save device 203. This makes it possible to prevent the management OS 2 from being damaged by the computer virus.

Assume that the level of safety of the management OS 2 is equal to or lower than that of the active OS 1. In this case, if the active OS 1 is damaged by malicious software such as a computer virus, the management OS 2 may be simultaneously damaged by the same cause. Hence, the computer may not be restored from the failure. For this reason, the management OS 2 preferably has a higher level of safety than the active OS 1. This makes it possible to reduce the probability of occurrence of a failure in the management OS 2 concurrently with the active OS 1 to almost zero (or a very low level).

In general, the active OS 1 needs to implement various functions necessary for the execution of applications, and hence cannot have a very high level of safety. In contrast to the active OS 1, since the function of the management OS 2 can be limited, its level of safety can be improved relatively easily.

If, for example, the active OS 1 is a WWW server, the OS may be damaged due to a security hole in the WWW sever. In contrast, since there is no need to install a WWW server in the management OS 2, the management OS 2 cannot be damaged by such a cause. By independently providing the function of restoring the active OS 1 from a failure for the management OS 2 having a higher level of safety than the active OS 1, a computer system with higher reliability than conventional systems can be realized.

By increasing the level of safety of the management OS 2 as compared with the active OS 1 in the above manner, it can be expected that even if the active OS 1 is broken down by a computer virus or the like, the management OS 2 can avoid breakdown. There are several general methods of increasing the level of safety.

The first method is a method of using, as the management OS 2, an OS which is known to have few (or no) security holes (in itself). In this case, as the management OS 2, an OS having few security holes (e.g., an OS having the fewest security holes among the existing OSs) need not be necessarily used, but an OS having fewer security holes than the active OS 1 may be used (an OS having no security hole is ideally used). Since the active OS 1 needs to operate a target application, a safe OS cannot always be selected. However, a safe OS can be selected as the management OS 2.

The second method is a method of improving the level of safety by limiting the function of the management OS 2 (even if identical OSs are used as the active OS 1 and management OS 2 or different OSs are used as the active OS 1 and management OS 2 but they have similar levels of safety). It suffices if the function of the management OS 2 is limited as compared with the active OS 1. The management OS 2 may have only a management function or may have other functions as well. In the active OS 1, in order to activate target applications, many necessary services must be installed and operated, and many necessary programs (commands) must be installed in advance. The management OS 2 is only required to be used for the management of the active OS 1, and hence the level of safety can be improved by inactivating unnecessary services (most of the services). In addition, since the management OS 2 requires only a limited number of programs (commands), deleting unnecessary programs (commands) makes it possible to decrease the danger of damage to the system by the activation of a command with a security hole.

The third method is a method of setting the management OS 2 in an operation environment different from that for the active OS 1. If, for example, the active OS 1 is a WWW server, the active OS 1 must always be connected to the Internet. However, the management OS 2 is aimed at managing the active OS 1, and hence need not be connected to the Internet. In addition, for example, a firewall may be used to limit access to the management OS 2 more severely than access to the active OS 1 from outside the network. Furthermore, functions unnecessary for this system, e.g., a voice input/output driver, can be inactivated in the management OS 2 in advance.

Although the level of safety can be increased by using at least one of the above three means, it is expected that the level of safety can be further increased by using a plurality of means together.

In addition to the above methods, this system can use a method of increasing the level of safety of the system by multiplexing management OSs 2 in, for example, managing important data, in particular. In this case, different OSs may be used for the respective multiplexed management OSs 2 (this can almost eliminating or greatly reducing the probability that data cannot be saved in the storage device 102 because all the multiplexed management OSs 2 are simultaneously damaged by a computer virus).

As described above, the management OS 2 is prepared independently of the active OS 1 to, for example, save data in accordance with the state of the active OS 1. This makes it possible to automatically keep storing data necessary for restoration of the active OS 1 from a failure in the memory save device 204 of the management OS 2. In addition, a better effect can be obtained by increasing the level of safety of the management OS as compared with the active OS. The user can restore the active OS 1 from a failure by using saved (stored) data. Alternatively, the user can restart the execution of a desired application on the basis of data saved before the occurrence of a failure.

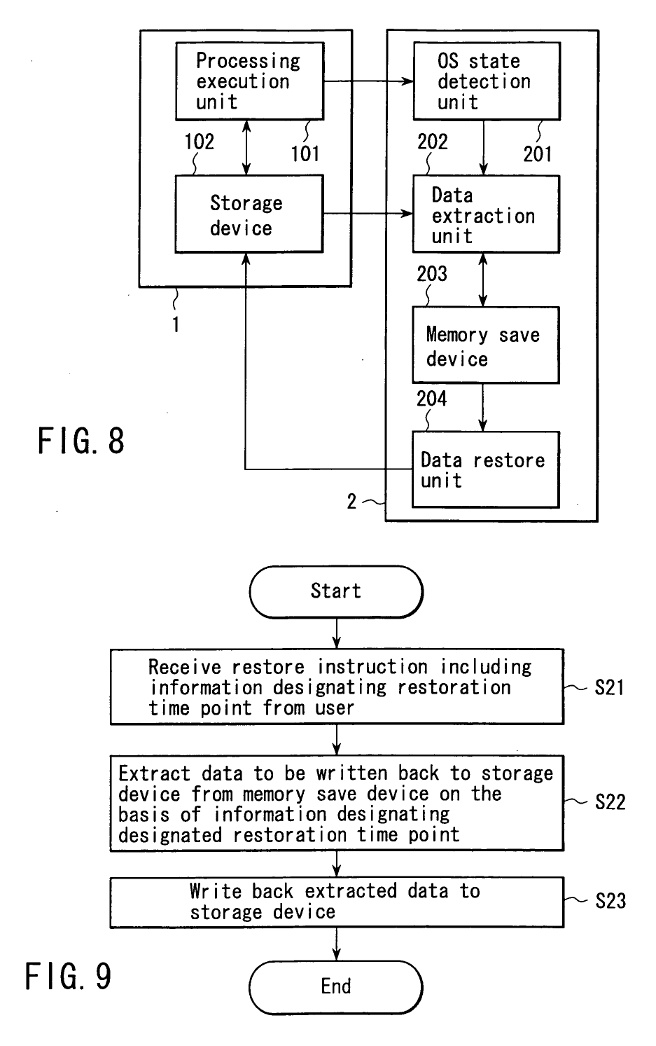

(Second Embodiment) FIG. 8 shows an example of the arrangement of a computer system including a data management system according to the second embodiment of the present invention.

In this arrangement, a management OS 2 (data management system) has a data restore unit 204 in addition to the arrangement shown in FIG. 1. Data save processing in the second embodiment is basically the same as that in the first embodiment. Differences from the first embodiment will be mainly described below.

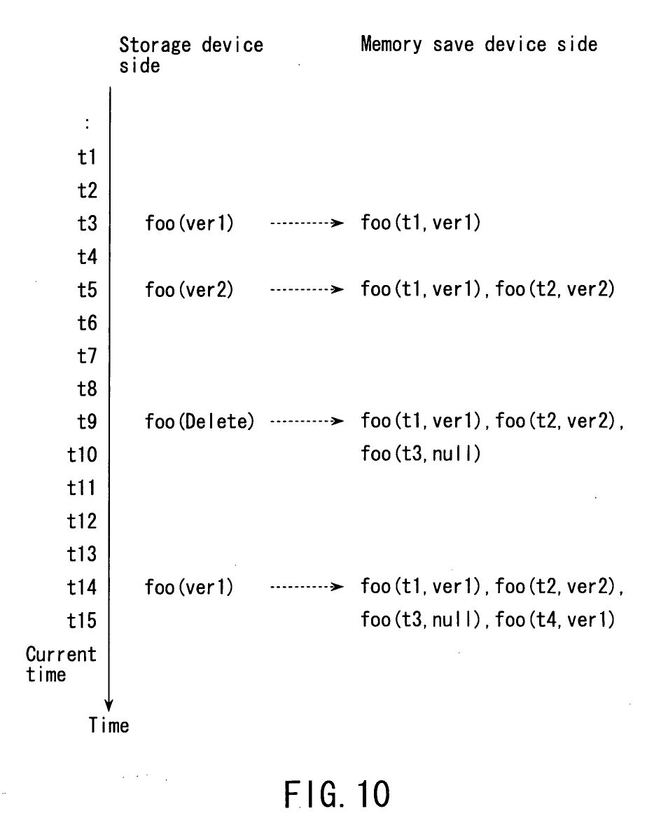

FIG. 9 shows an example of a sequence in which the management OS 2 writes back saved data from a memory save device 203 to a storage device 102.

The management OS 2 receives a restore instruction including information designating a restoration time point from a user (step S21).

The data restore unit 204 extracts data to be written back to the storage device 102 from the memory save device 203 on the basis of the information designating the restoration time point (step S22).

The memory save device 203 writes back the extracted data to the storage device 102 (step S23).

Various kinds of methods of designating restoration time points are conceivable.

For example, the user may designate a desired date and time (or the time to be measured from the current time or the like). The data restore unit 204 may select a time point, from the restorable time points at which the contents of the storage device 102 can be restored (e.g., the past time points at which data was actually saved), which is nearest to the designated date and time (or one of the time points before the designated date and time which is nearest to the designated date and time). The data restore unit 204 then may extract data to be written back to the storage device 102 from the memory save device 203 so as to restore the storage device 102 to the state at this time point.

Consider, for example, saving/restoration of a file named “foo”. Assume that information about the file named “foo” was saved at times t3, t5, t9, and t14, as shown in FIG. 10. Assume also that this file did not exist before time t3, and information indicating that the file was deleted was saved at time t9. When, for example, the user designates time t8 as a restoration time, time t5 is selected for the file named “foo”, which is the nearest time among the restoration times before time t8. Restoration is then performed by using the data of version number 2 which was saved at the selected time (for example, the data of version number 2 is written back to the storage device 102). When, for example, time t4 is designated, time t3 is selected, which is the nearest restoration time before time t4. Restoration is then performed by using the data of version number 1 which was saved at the selected time. When, for example, time t1 or t2 is designated, since no file named “foo” exists, corresponding restoration is performed (for example, the file named “foo” is deleted from the storage device 102). When, for example, time t15 is designated, time t14 is selected, which is the nearest restoration time before time 15. Restoration is then performed by using the data of version number 1 which was saved at the selected time. Note that foo(t14, ver1) is equal in version number to foo(t3, ver1), but differs in time information, and hence differs in contents. That is, foo(t14, ver1) is a file created again after the file named “foo” is deleted.

In addition, for example, the user may designate a desired date and time or the like and the operation state of the active OS 1 (e.g., a shutdown, booted, or installed state) which is detected in saving data. The data restore unit 204 may then select a time point, from the restorable time points at which the operation state detected in saving data coincides with the designated operation state, which is nearest to the designated date and time (or a date and time among restoration dates and times before the designated date and time which are nearest to the designated date and time).

Furthermore, for example, the management OS 2 may present a list of dates and times or the like which indicate restorable time points (or combinations of dates and times or the like and the operation states of the active OS 1) on the basis of the information stored in the memory save device 203. The user may then select a desired date and time from the presented dates and times or the like (or the combinations of dates and times or the like and the operation states).

Alternatively, file names may be designated, and only files with the designated file names may be restored.

Various other variations can be made.

The execution of failure restoration will be described in detail below.

First of all, the occurrence of a failure in the active OS 1 is found by the user when he/she recognizes an inability to use all or part of software during the operation of the software or unexpected behavior of the computer as well as a failure in hardware.

When the user recognizes the occurrence of a failure in the active OS 1, the operation of a processing execution unit 101 is temporarily stopped. If a failure or the like has occurred in hardware, the system can be restored from the failure by writing back the contents of the storage device 102 to the state before the occurrence of the failure after the hardware is repaired.

As described above, it is guaranteed (or expected) that data necessary for failure restoration is stored in the memory save device 203. However, the data stored in the memory save device 203 are all the data recorded in the past (or data associated with states at a plurality of time points on the time series), and can contain data unnecessary for failure restoration. First of all, the data restore unit 204 extracts data to be written back to the storage device 102 from the data stored in the memory save device 203.

What data should be written back is determined case by case, and may be determined by, for example, a system manager. If, for example, it is determined that the active OS 1 was infected with a computer virus three days ago at 3:00 p.m., the user tries to restore the computer to the state before the infection. This state may be the state three days ago at 2:59 p.m. or the state at the time of shutdown of the active OS 1, e.g., three days ago at 5:00 a.m. Alternatively, this state may be the state set by restoring the current state to the state three days ago at 5:00 a.m. and adding added files to a specific portion (directory) by 2:59 p.m. This state varies depending on the properties of the active OS 1 in use, and is determined by the system manager or the like. When this determination information is input to the data restore unit 204, the data restore unit 204 starts failure restoration processing.

Although the system manager or the like inputs determination information, no such information may be input depending on the system configuration. For example, the active OS 1 may always be restored to the state at a time point at which the active OS 1 was previously shut down.

The data restore unit 204 extracts data to be written back to the storage device 102 from the memory save device 203 in accordance with input determination information for determining a restoration method or a predetermined restoration method, and writes the data in the storage device 102. When the write operation to the storage device 102 is completed, since it means that the state of the active OS 1 which is free from any failure can be reproduced, failure restoration can be done by causing the processing execution unit 101 to restart the active OS 1.

The system may be configured such that after the state of the storage device 102 is restored to the state at a given time point, that data of the data stored in the memory save device 203 which is necessary for restoration to an arbitrary state after the given time is discarded.

Consider a case wherein the user can recognize the occurrence of a failure in the active OS 1 but cannot determine any specific state at any specific time point to which the state of the storage device 102 should be restored. For such a case, the data restore unit 204 may have a function of temporarily restoring the state of the storage device 102 to the state designated by the user. In this case, the user repeatedly starts the active OS 1 in the temporarily restored state of the storage device 102 and determines whether or not the system has been restored from the failure, while gradually backdating the designated state of the storage device 102, thereby finding the state in which the system is restored from the failure. The user then gives the management OS 2 an instruction to confirm the state of the storage device 102 at this time. The data restore unit 204 may confirm the state of the storage device 102 in accordance with this instruction.

(Third Embodiment)

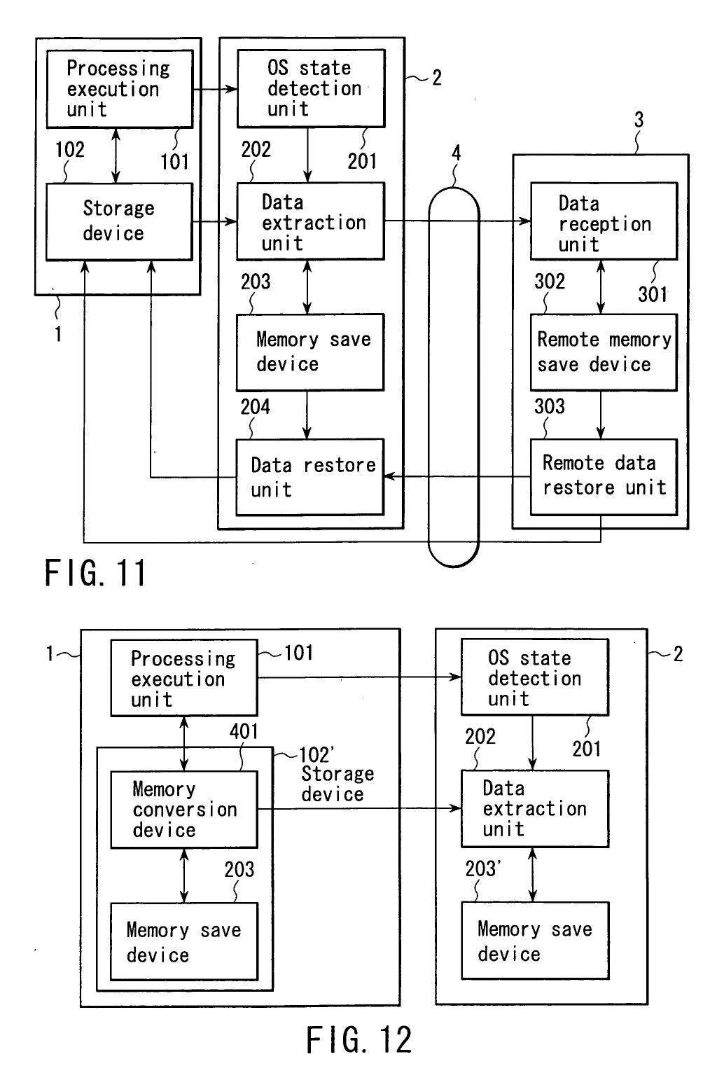

FIG. 11 shows an example of the arrangement of a computer system including a data management system according to the third embodiment of the present invention. In this example, the data management system includes a remote management device 3 in addition to the management OS 2 in FIG. 2. Saving of data and restoration from a failure are basically the same as those in the second embodiment. Differences from the example of the arrangement in FIG. 8 will be mainly described below.

The remote management device 3 is connected to the management OS 2 through, for example, a network 4. One or a plurality of remote management devices 3 may be used. For the sake of simplicity, assume that one remote management device 3 is used. Typically, the remote management device 3 can be installed in a remote place such as a server center through a network such as the Internet or a telephone line. However, the present invention is not limited to this. For example, the remote management device 3 may be used as an auxiliary device for the computer, and an active OS 1, the management OS 2, and the remote management device 3 may be integrally installed.

A data extraction unit 202 of the management OS 2 not only stores data necessary for failure restoration in a memory save device 203, but also transmits the data to a data reception unit 301 of the remote management device 3 (to store it in a remote memory save device 302).

There are various methods of storing data in the memory save device 203 and remote memory save device 302: the first form in which memory saving is duplexed (a method of storing identical data in the memory save device 203 and remote memory save device 302); the second form in which only partial data is duplexed (a method of storing, in the remote memory save device 302, only part of the data stored in the memory save device 203); and the third form in which a storage method are controlled for each data (a method of determining whether to store data in only the memory save device 203 or only the remote memory save device 302 depending on the data).

As a concrete example of the second form, a method is conceivable, in which the data extraction unit 202 of the management OS 2 stores all data necessary for failure restoration in the memory save device 203 which the management OS 2 itself has, and stores only important data (e.g., data associated with library files in the system) of the data necessary for failure restoration in the data reception unit 301 of the remote management device 3.

The data reception unit stores all the received data in the remote memory save device 302. Note that the data reception unit 301 can also be configured to store only part of received data which is determined to be important in the remote memory save device 302.

Storing data necessary for failure restoration not only in the memory save device 203 but also in the remote memory save device 302 in this manner can further increase the level of safety.

If, for example, the active OS 1 and management OS 2 are located in the same place, they can be physically destroyed at once by a fire or the like. However, installing the remote management device 3 in another place, e.g., a server center, connected through the Internet makes it possible to store data necessary for failure restoration more reliably. Even if the active OS 1 and management OS 2 are physically destroyed at once, failure restoration can be realized by using the data stored in the remote memory save device 302.

A typical application example of this system is that the remote management device 3 is installed in a server center which is connected to the Internet and managed with especially high safety so as to provide the user with a computer which can be restored from a failure without giving consideration to any risk such as destruction of the management OS 2.

A remote data restore unit 303 has the same function as that of the data restore unit 204 according to the present invention, i.e., the function of extracting data to be written back to a storage device 102. The remote data restore unit 303 extracts necessary data from the remote memory save device 302 and transmits it to the data restore unit 204. The data restore unit 204 writes data necessary for failure restoration by using only the data received from the remote data restore unit 303, only the data extracted from the memory save device 203, or data from the remote data restore unit 303 and memory save device 203. The remote data restore unit 303 may directly send data to the storage device 102 without transmitting any data to the data restore unit 204, and may use no data in the memory save device 203. In general, the remote management device 3 is used in the server center through a network. However, server center staff who have received a failure report may bring the remote memory save device 302 (hard disk or the like) with him/her to the installation place of the active OS 1 so as to restore the storage device 102.

Note that the arrangement example in FIG. 11 is equivalent to an example obtained by adding the remote management device 3 to the arrangement example in FIG. 8. However, the remote management device 3 (without the remote data restore unit 303) may be added to the arrangement in FIG. 1.

(Fourth Embodiment)

FIG. 12 shows an example of the arrangement of a computer system including a data management system according to the fourth embodiment of the present invention. In this arrangement example, in order to perform failure restoration processing more quickly, a memory conversion function is added to the storage device 102 in FIG. 1. Data save processing in this embodiment is basically the same as that in the first embodiment. Differences from the first embodiment will be mainly described below.

Assume that when the occurrence of a failure is detected, a memory save device 203 on the active OS 1 side is connected to the management OS 2 side, and data necessary for restoration from the failure has been stored as in the first embodiment (see FIG. 1).

In this embodiment, after the occurrence of the failure is detected, the memory save device (not shown) held by the active OS 1 is removed, and the memory save device 203 held by the management OS 2 is removed (actually transferred) and connected to the active OS 1 side (FIG. 12 shows this state).

In this embodiment, a processing execution unit 101 reads out and writes data from and in a memory conversion device 401.

The memory conversion device 401 writes the write data received from the processing execution unit 101 in the connected memory save device 203 without any change. This indicates that the memory conversion device 401 writes the necessary data without destroying it in consideration of a time series. This operation is equivalent to making the data extraction unit 202 in FIG. 1, which has already been described, write data in the memory save device 203.

When the processing execution unit 101 is to read out data, it reads out data by the memory conversion device 401.

In reading out data from the memory save device 203 (which has been removed from the management OS 2 and connected upon detection of the occurrence of a failure), the memory conversion device 401 reads out data immediately before the occurrence of the failure instead of data after the occurrence of the failure. The memory conversion device 401 has a function of reading out, for example, data of three days ago if the user designates it.

The memory conversion device 401 may have functions like that of the data extraction unit 202 and that of the data restore unit 204.

When the processing execution unit 101 writes and reads out data in and from the memory save device 203 through the memory conversion device 401 in this manner, it looks as if the processing execution unit 101 could be made to write and read out data in and from a general storage device. That is, if a storage device 102′ is formed from a combination of the memory conversion device 401 and the memory save device 203, the storage device 102′ has a function similar to that of the general storage device 102 in FIG. 1.

After the memory save device is moved, the data extraction unit 202 of the management OS 2 may receive data from the storage device 102′ (data from the memory conversion device 401 in reality) and write the data in a memory save device 203′ newly connected in place of the memory save device 203.

Performing failure restoration upon addition of the memory conversion device 401 in this manner makes it possible for the active OS 1 to instantaneously operate in the state before the occurrence of the failure. According to this method, restoration from a failure can be instantaneously made. The method is therefore especially effective for a computer system wherein it is important to prevent the active OS 1 from being stopped for a long period of time or to keep it operating without any interruption, e.g., a computer system which provides services on an online shopping site or the like.

If this arrangement is considered as an arrangement in which a storage device and memory save device each incorporate the memory conversion device 401 and memory save device 203 from the beginning instead of being considered as a temporary, special arrangement, an arrangement configured to switch the OSs, every time a failure occur, without discriminating the storage device and memory save device. In this case, if the memory conversion device 401 also functions as the data extraction unit 202 in the management OS 2, the data extraction unit 202 can be omitted.

FIG. 12 shows an example of performing failure restoration on the basis of the data in the memory save device 203 of the management OS 2. However, the remote management device 3 (without the remote data restore unit 303) in FIG. 11 may be added to the arrangement example in FIG. 12 to perform failure restoration on the basis of the data in the memory save device 203 or remote memory save device 302, at the time of detection of the occurrence of a failure, by connecting the memory save device 203 of the management OS 2 or the remote memory save device 302 of the remote management device 3 to the active OS 1 side as in the above case.

In addition, since this example is made to speed up the temporary restoration apparatus at the time of occurrence of a failure, the system may be made to operate on only the active OS 1 to which the memory conversion device 401 is added while the management OS 2 is temporarily removed.

(Modification)

Modifications of the respective arrangements described in the first through fourth embodiments will be described below.

<1> As a technique of improving the performance of the computer system according to each embodiment, a technique of reducing the amount of data stored can be used. If the data extraction unit 202 of the management OS 2 is to sequentially store extracted data in the memory save device 203 without any change, the amount of data to be stored become enormous. However, the amount of data stored can be reduced (i.e., the system can be converted into a form that requires a less amount of data) by reading out past saved data that has already been stored in the memory save device and reusing it. This can improves the performance of the system.

For example, the amount of data stored can be greatly reduced by omitting the storage of unit data (file) whose contents have not been changed or storing only differential data of unit data (file) whose contents have been partly changed. This technique can also be used when the data reception unit 301 in the remote management device 3 stores data in the remote memory save device 302.

In addition, this technique can be used when the OS state detection unit 201 detects the end of execution of the active OS 1 and corresponding information 3 can be used when data is extracted from the storage device 102.

According to an example of this method, for example, at the end of execution of the active OS 1, data more detailed than data that is generally stored may be stored. That is, data unique to the end of execution which differs from data during the operation of the active OS is additionally stored.

In another example of this method, after the end of execution of the active OS 1, all the data contents in the storage device 102 are held. In other cases, only differential data based on data at the end of previous execution of the active OS 1 is stored. This makes it possible to store data necessary for failure restoration more efficiently.

In addition, using such a method may make it easy to determine which data should be used for failure restoration processing. For example, in some cases, displaying “data of three days ago at the latest time of the end of execution of the OS” may be convenient than displaying “data of three days ago at 3:21 p.m.”.

By detecting the end of execution of the active OS and using the corresponding information in extracting data from the storage device in this manner, it can be expected that the efficiency of data storage processing is improved, and the failure restoration processing is simplified.

In addition, since the OS state detection unit 201 can detect the end of execution of the active OS 1, there is no need to perform special processing such as “activation of failure restoration function”. In spite of the fact that the active OS 1 and management OS 2 are operating, the user of the computer can use the active OS 1, which is normally used, with the feeling of keeping using the active OS 1 as if the active OS 1 is operating alone.

<2> In addition, the OS state detection unit 201 can detect that the processing execution unit 101 of the active OS 1 has changed data in the storage device 102, and the corresponding information can be used when data is extracted from the storage device 102. In general, the management OS 2 needs to repeatedly searching the overall storage device 102 of the active OS 1 in order to detect a change in the contents of the storage device 102 of the active OS 1 in real time by only seeing the contents of the storage device 102. If, however, the active OS 1 has a means for directly notifying the data extraction unit 202 of a change in the contents of the storage device 102, it is only required to search only that portion of the contents of the storage device 102 which is detected to have been changed. This improves the data extraction efficiency. For example, this function can be implemented by modifying the system call mechanism associated with data processing in the processing execution unit 101 of the active OS 1 into a mechanism of notifying the data extraction unit 202 of information (a file name, node number, and the like) associated with the storage device.

<3> As a method of implementing this embodiment in a general computer, there is available a technique of using virtual computer software for executing another Os.

As virtual computer software, for example, VMware (J. Sugerman et al., Virtualizing I/O Devices on VMware Workstation's Hosted Virtual Machine Monitor, 2001 USENIX Conference, 2001/7/25) is available.

In this case, virtual computer software that operates on one main OS (to be referred to as a host OS) is prepared. This virtual computer directly executes the CPU and incorporates various peripheral devices upon virtualizing them. This makes the virtual computer operate as if an actual computer operated, and allows the virtual computer to operate with performance almost equal to that of the actual computer. One or a plurality of pieces of virtual computer software can be made to operate on the host OS, and secondary OSs (to be referred to as guest OSs) can be implemented in the respective virtual computers. As a consequence, two or more OSs, i.e., a desired number of OSs, can be made to simultaneously operated on one computer. Using this mechanism makes it possible to simultaneously implement the active OS 1 and management OS 2 in one computer.

This allows easy implementation of this computer system by using one computer without preparing any special computer.

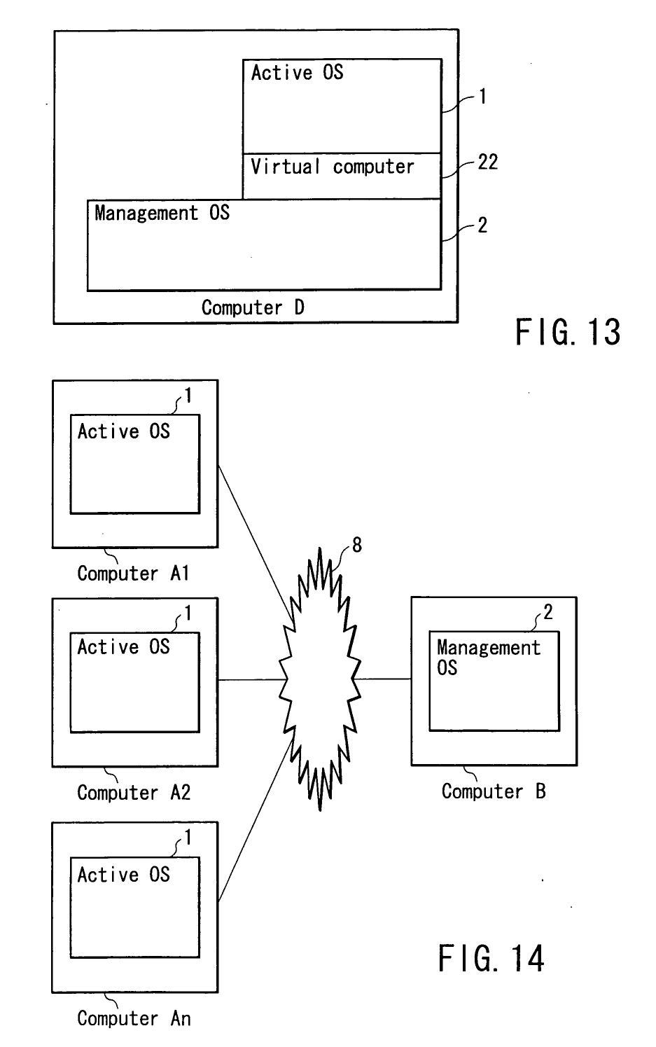

In implementing this embodiment in a computer, as shown in FIG. 13, the management OS 2 can have virtual computer software for executing other OSs, and the active OS 1 can operate on the software 22. For reliable failure restoration, the active OS and management OS are preferably operated at the same time. However, using virtual computer software can easily implement this computer system by using one computer without preparing any special computer.

There are the following advantages in using virtual computer software. Since the active OS 1 and management OS 2 share the same hardware, an implementation for making the OS state detection unit of the management OS 2 receive information from the processing execution unit 101 of the active OS 1 can be easily made. In addition, an implementation for making the data extraction unit 202 of the management OS 2 receive data from the storage device 102 of the active OS 1 can be easily made.

Furthermore, in failure restoration as well, the above technique makes it easy to make an implementation for making the data restore unit 204 write data for restoration in the storage device 102 on the basis of data from the memory save device 203. In addition, it can be expected that the performance of the data restore unit 204 improves.

In this method, since a guest OS is implemented on the host OS, it seems unlikely, in general, that the level of safety of the guest OS exceeds that of the host OS. This is because when the host OS is destroyed, the guest OS is inevitably destroyed with high possibility. The active OS 1 is generally thought to be implemented as a guest OS. The management OS 2 can be thought to be implemented as both a guest OS and a host OS.

In addition, a plurality of active OSs 1 can be implemented as guest OSs with respect to one management OS 2, or the remote management device 3 can be implemented as this guest OS or host OS.

In this case, the guest OS can be started at the same time when the host OS is started. Therefore, the following environment can be naturally realized. In spite of the fact that the active OS 1 and management OS 2 are operating, the user of the computer can use the active OS 1, which is normally used, with the feeling of keeping using the active OS 1 as if the active OS 1 were operating alone.

<4> According to the above description, one management OS 2 is used for one active OS 1 as a management target. As shown in FIG. 14, however, one management OS 2 may be used for a plurality of active OSs 1 as management targets. FIG. 14 shows a case wherein the management OS 2 operating on a computer B connected to n computers A1 through An through a network 8 such as a LAN or the Internet manages the active OSs 1 operating on the computers A1 through An.

Note that each of the above functions can be implemented by a computer having the above proper function as software.

In addition, these embodiments can be implemented as programs for causing a computer to execute predetermined means, causing the computer to function as predetermined means, or causing the computer to implement predetermined functions, and can be implemented as a computer-readable recording medium on which the programs are recorded.

Note that the present invention is not limited to the above embodiments, and can be implemented by modifying the constituent elements in the execution stage within the spirit and scope of the invention. Various inventions can be made by proper combinations of a plurality of constituent elements disclosed in the above embodiments. For example, several constituent elements are omitted from the all the constituent elements in the embodiments. Furthermore, constituent elements of still another embodiment may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data management system comprising:
a target operating system which is to be restored from a failure;
a storage device which stores the target operating system and data; and
a management operating system which is independent of the target operating system, including:
an operation state detection unit configured to detect an operation state of the target operating system when the operation state of the target operating system corresponds to one of a plurality of predetermined operation states;
an extraction unit configured to extract data to be saved from the storage device in accordance with the operation state detected by the operation state detection unit; and
a save storage unit configured to save the extracted data.

2. A system according to claim 1, wherein the management operating system has fewer security holes than the target operating system.

3. A system according to claim 1, wherein the management operating system is more limited in function than the target operating system.

4. A system according to claim 1, wherein the target operating system includes a function of connecting to an external network, whereas the management operating system includes no function of connecting to an external network.

5. A system according to claim 1, wherein access from an external network to the management operating system is more restricted than access from an external network to the target operating system.

6. A system according to claim 1, wherein software of the management operating system operates on the same computer on which software of the target operating system operates.

7. A system according to claim 1, wherein the management operating system includes virtual computer software capable of executing software of the target operating system, and the software of the target operating system operates on the virtual computer.

8. A system according to claim 1, wherein software of the management operating system operates on a computer different from a computer on which software of the target operating system operates.

9. A system according to claim 1, further comprising one or a plurality of remote management devices installed independently of the management operating system,
the remote management device including a remote save storage unit which saves all or part of the data extracted by the extraction means.

10. A system according to claim 1, wherein the management operating system further comprises a unit configured to write back data saved in the save storage unit to the storage device to restore contents of the storage device to a state at a given time point in the past.

11. A system according to claim 9, wherein the management operating system further comprises a unit configured to write back data saved in the save storage unit or the remote save storage unit to the storage device to restore contents of the storage device to a state at a given time point in the past.

12. A system according to claim 9, wherein the remote management device further comprises a unit configured to write back data saved in the remote save storage unit to the storage device to restore contents of the storage device to a state at a given time point in the past.

13. A system according to claim 1, wherein the target operating system includes a unit configured to read out data saved in the connected save storage unit, as data stored in the storage device, at a given time in the past when the save storage unit is connected.

14. A system according to claim 9, wherein the target operating system includes a unit configured to read out data saved in the connected save storage unit or remote save storage unit as data stored in the storage device at a given time point in the past when the save storage unit or the remote save storage unit is connected.

15. A system according to claim 1, wherein the extraction unit includes a conversion unit configured to convert the extracted data into a form with a less data amount on the basis of saved data which has already been saved, before the extracted data is saved.

16. A system according to claim 1, wherein the predetermined operation state includes a first operation state indicating that the target operating system terminates execution thereof.

17. A system according to claim 1, wherein the predetermined operation state includes a second operation state indicating that the target operating system starts execution thereof.

18. A system according to claim 1, wherein the predetermined operation state includes a third operation state indicating that the target operating system executes installation of an application program.

19. A system according to claim 1, wherein the predetermined operation state includes a fourth operation state indicating that the target operating system has changed data in the storage device.

20. A data management method of causing a management operating system independent of a target operating system to manage data in a storage device which the target operating system has, comprising:
detecting an operation state of the target operating system when the operation state of the target operating system corresponds to one of a plurality of predetermined operation states;
extracting data to be saved from the storage device in accordance with the detected operation state; and
saving the extracted data in a save storage device.

21. A program for causing a computer to function as a data management apparatus which causes a management operating system independent of a target operating system to manage data in a storage device which the target operating system has, the program causing the computer to implement:
a function of detecting an operation state of the target operating system when the operation state of the target operating system corresponds to one of a plurality of predetermined operation states;
a function of extracting data to be saved from the storage device in accordance with the detected operation state; and
a function of saving the extracted data in a save storage device.
